(19) United States
(12) Patent Application Publication
(10) Pub. No.: US 2015/0201583 A1
(43) Pub. Date: Jul. 23, 2015

(54) METHOD FOR THE TREATMENT OF ANIMALS WITH HOOVES

(71) Applicant: John Greeson, Roswell, NM (US)

(72) Inventor: John Greeson, Roswell, NM (US)

(21) Appl. No.: 14/157,741

(22) Filed: Jan. 17, 2014

(51) Int. Cl. A01K 13/00; G01L 5/16

(52) U.S. Cl. CPC A01K 13/003; G01L 5/16

(57) ABSTRACT

A method and system that incorporates spraying logic onto the sensor mat to detect and apply various liquids onto the feet of an animal. Each sensor in the sensor mat actuates a specific valve for application of the medicinal fluid without the use of relays and associated wiring. The medicinal fluid is a topical anti-inflammatory/vaso dilator to prevent swelling, hemorrhaging, and further tissue elimination, commonly known as laminitis, abscess, ulcers and white line disease. The application of the medicinal fluid can be administered to only specific animals by tagging the animals that require treatment.

### RELATED APPLICATION

This application claims the benefit of U.S. Provisional Application No. 61/761,889, filed Feb. 7, 2013, the specification of which is incorporated herein by reference.

### BACKGROUND OF THE INVENTION

1 Field of the Invention (Technical Field):

The presently claimed invention relates to treatment of animals and more particularly to a method and system for automatically providing treatment fluids to hoofed animals.

2. Background Art:

Control and management of insects and other pests on domesticated animals has proven challenging, costly, often elusive, and frequently ineffective. Pests among dairy herds dramatically affect the economics of animal production and milk production, a commercial industry constituting a significant contribution to the gross national product of the United States. It is estimated that the dairy cattle industry, for example, produces $38 billion annually. Failure to deal with pests can cause a number of problems, including irritations to cows so severe that milk production suffers, disease pathogens transmit from cow to cow, and a variety of regulatory rules and regulations are violated for failure to treat such pests. The present invention has provided exemplary solutions for solving problems arising from pests among dairy herds as shown in U.S. Pat. No. 6,230,660 issued May 15, 2001; U.S. Pat. No. 6,651,589 issued Nov. 25, 2003; 2001; U.S. Pat. No. 6,779,489 issued Aug. 24, 2004; and U.S. Pat. No. 7,194,980 B2, issued Mar. 27, 2007 (collectively, “Prior Applications and Patents”).

The problems solved by the Prior Applications and Patents include a wide range of diseases, infections, and injuries to the feet and other anatomical regions of animals and mammals, including cattle that are part of dairy herds. In addition to treating diseases, infections and injuries on the feet of dairy cows, it is useful to apply various ingredients for preventative treatment to achieve resistance to diseases and lacerations, to harden hooves to resist physical injury, and to achieve similar and related objectives. Livestock in a dairy herd are susceptible to forming a variety of warts, abscesses, sole ulcers, foot rot, heel cracks, and variations of lesions or infections on their feet and/or hooves. These problems individually or collectively cause livestock to suffer lameness, clubbed hooves, loss of body weight, decreased milk production, and a decreased rate of conception. In the present invention, the term “animal treatment problems” includes these problems, but is not limited in any way.

U.S. patent application Ser. No. 11/458,935 for an ANIMAL FOOT TREATMENT SYSTEM filed Jul. 20, 2006, and U.S. Publication No. and US/2008/0121189 A1, published on May 29, 2008, present exemplary solutions to such problems.

U.S. Pat. No. 8,276,545 B2, for ANIMAL FOOT TREATMENT, issued Oct. 2, 2012, presents another solution; however, this system is complex and requires several external components to provide control for the efficient application of the medicinal fluid to the location of each hoof. The present application presents significant improvements to this prior art patent, minimizing the complex electronics, and simplifying the sensor mat.

Alternative apparatuses and methods suggested as solutions for application of ingredients to animals are potentially hazardous both to humans and to animals. For example, a common way to apply topical solutions to hooves of animals is a form of bath, footbath, tub, or container (in this document, “bath”) through which an animal walks. Concentrations of ingredients in baths used for chemical treatment of animal foot problems render ineffective results because debris deposited in the ingredients in the form of animal waste passes through the bath. Accordingly, to insure continued efficacy of a bath, baths need to be regularly cleaned and refilled with fresh ingredients. Unfortunately, the cleaning and refilling of baths is generally a manual chore often ignored. After a short period, this results in an inefficacious bath. Therefore, until development of the system shown in the present invention, applying and maintaining precise concentrations of ingredients has proven problematic.

Bath application methods are comparatively expensive and inefficient; therefore, in an effort to achieve appropriate coverage and treatment, excessive quantities of expensive chemicals and chemical combinations are incorporated. Debris deposited in the bath acts to reduce the efficacy of the footbath solution. As more animals pass through the bath, the debris deposited continually degrades, rendering the bath contents inefficacious. Therefore, to compensate for this effect, the chemical concentration in the bath must be at sufficient strength to insure that the contents of the bath will still be efficacious when the last animal traverses the bath. Thus, the concentration of the solution in the bath must be much stronger than required for the first animal passing through the bath to be effective enough for the last animal passing through the bath because of the degrading effect of continuous debris deposition.

Baths in which animals place their feet may also cause pollution and injury to animals and/or humans. For example, copper sulfate commonly used in treating cows and the discharge of copper sulfate from bath treatment systems into adjacent lands may cause significant damage to croplands and is not sustainable because the legal limit for discharge cannot exceed a determined parts per million. Another chemical used extensively in the dairy industry is formaldehyde, which causes burns to humans and animals, and can result in the loss of eyesight and even death among workers. For these reasons, the European Union has called for a ban of the use of formaldehyde, a decision made more compelling because the United States recognizes it as a known carcinogen. Formaldehyde in comparatively large concentrations in a bath application system may damage the feet of cattle. Use of the animal treatment system disclosed in the present invention eliminates those problems and others associated with contamination, pollution, and injury caused by excessive concentrations of one or more chemicals in a footbath system. At the same time, it decreases the costs of effective applications of ingredients.

For example, studies show that the animal treatment system disclosed in the present invention may reduce the quantities of expensive chemicals. The result is a significant reduction in the use of costly chemicals, potential pollution, and accompanying costs.

As indicated, the animal treatment system disclosed in the present invention is capable of selective discharge and application. A consequence of selective targeting of expensive chemicals reduces the overall costs of contending with animal treatment problems. The animal treatment system of the present invention, therefore, provides flexibility by allowing use of precise ingredients to treat a precise problem.

Another problem with the prior art methods of treatment is that all of the animals are treated equally during any treatment cycle. However, certain animals may require more frequent treatments due to certain or more severe conditions. Thus, a system to apply treatment to predetermined animals more frequently than others is necessary.

One example among many is the treatment of digital dermatitis also known in the dairy industry as hairy heel warts. Over 90% of the time digital dermatitis generally occurs on the back of a cow's rear feet, but is also known to occur between the cow's toes and/or claws and on front feet as well. In the present application, due to the animal treatment system's ability to selectively target specific anatomical regions of a cow for treatment, studies have shown that chemical usage, as a result of this animal treatment system, can be reduced by 70% -90%. For treating digital dermatitis, the animal treatment system of the present invention appears to be at least four times more efficient to use than any other known footbath or bath treatment system.

Yet another advantage of the animal treatment system of the present invention is treatment of varying conditions of an anatomical region during varying cycles of an animal treatment regime. In a dairy herd environment, the hooves of cows change solidity in direct relationship to the lactation cycle of the cow. The term “lactation cycle” refers to the period during which the mammary glands of a cow produce milk. A cow entering commencement of a lactation cycle may not have had foot treatment for the 2-4 month “dry period” before calving and not being milked, and therefore was not passing through the footbath. During that period, a cow's foot may become softer than it was during the lactation cycle when routinely passing through a bath. Softness may later result in development of significant abscesses, ulcers, or erosions that will ultimately have to be treated. Additionally, because cows typically are not exposed to baths during the “dry period”, certain foot lesions or diseases become more pronounced. Use of the animal treatment system of the present invention allows changes in chemical compositions of applications of ingredients to reflect such varying problems, which are unique to the dairy industry.

The systems, apparatuses, and methods disclosed, illustrated, and claimed in the previously filed patent applications by the Applicant have proven useful for the intended purposes and applications described in that document. However, the present disclosure provides significant improvements to the actuating and delivery methods and systems. The prior art systems work well in providing the treatment, but the mat structure tended to wear out and fatigue after repeated use. Therefore, a system was needed to prevent these conditions. The drawing figures, additional contributions to the art disclosed, illustrated, and claimed in the present invention provide other optimizations and embodiments in which the principles of operation, with different configurations, result in additional features and uses. Consequently, additional advantages, of the animal treatment system disclosed, illustrated, and claimed in the present invention will become evident. None of the currently available suggestions for addressing animal treatment problems is as effective as the suggestions disclosed in the presently claimed invention.

It is apparent that a need exists in the industry for a new and useful system to treat animal feet and/or hooves that is capable of applying precise amounts of ingredients, at precise times, and during precise lengths of time. The applied treatment is for selected anatomical regions of animals to achieve a cost-effective and treatment-effective application of these ingredients to overcome animal treatment problems. Further, there is a need for the system to avoid unnecessary complexities in the system. Additionally, to improve blood flow in the hooves of animals that prevents or reduces swelling in their feet, the present invention discloses an improved chemical compound.

### SUMMARY OF THE INVENTION (DISCLOSURE OF THE INVENTION)

The presently claimed invention solves the aforementioned problems. The presently claimed invention provides for several improvements to the prior art systems. First, a chemical is presented that improves blood flow in the hooves of animals to prevent or reduce the swelling in their feet. Secondly, a simplified hoof treatment system is implemented to make it practical and less expensive to manufacture. This system does not require expensive electronic devices on the footpad and relies on the properties of the footpad construction for activation of the spray regime. Additionally, the mat structure has been improved by stop bars on either side of each pressure sensor to limit the distance of compression on the pressure sensors. The pressure sensors have also been redesigned with a firm flexible rubber tube, like a PVC pipe, encased in a compressible material, such as rubber. When pressure is exerted on the pressure sensor, the firm flexible rubber tube presses against the top contact, that ultimately makes contact with the bottom contact. This operates essentially as a switch, activating the specific spray nozzles that are related to the pressure sensor. Finally, a method and system are presented to treat only selected animals so that the entire herd does not need to be treated or to provide specific treatment to specific animals with specific conditions.

Other objects, advantages, novel features, and further scope of applicability of the presently claimed invention will be set forth in part in the detailed description to follow. The description is to be used in conjunction with the accompanying drawings, and in part will become apparent to those skilled in the art upon examination of the following, or may be learned by practice of the claimed invention. The objects and advantages of the claimed invention may be realized and attained by means of the instrumentalities and combinations particularly pointed out in the appended claims.

### BRIEF DESCRIPTION OF THE DRAWINGS

The accompanying drawings, incorporated herein and form a part of the specification, illustrate several embodiments of the present invention, and together with the description, serve to explain the principles of the invention. The drawings are only for the purpose of illustrating a preferred embodiment of the invention and should not be construed as limiting the invention.

In the drawings:

FIG. 1A shows the preferred animal treatment system.

FIG. 1B shows a blow up of the spray nozzle.

FIG. 2A shows a portion of the mat without hoof compression.

FIG. 2B shows a portion of the mat with hoof compression.

FIG. 3 shows the preferred spray pattern and location on a hoof.

FIG. 4 shows a top view of the preferred mat.

FIG. 5 shows an exploded view of the mat and cover.

### DESCRIPTION OF THE PREFERRED EMBODIMENTS (BEST MODES FOR CARRYING OUT THE INVENTION)

### Logical Sensor Mat for Appling Liquids

As used in this disclosure, the term “foot” means not only the terminal part of a vertebrate animal's leg, but also the hoof, the pad, the pastern, the dewclaw, the hock and the portion below the knee or hock on an animal such as a domestic bovine. Although the examples discussed in this disclosure are limited to dairy cows, the claimed invention includes treatment of any type of animal.

The claimed invention relates to the use of incorporating spraying logic into the sensor mat to detect and apply various liquids onto the feet of an animal or human. The system described in U.S. Pat. No. 8,276,545 (hereinafter '545 patent) is complex and has sensitive electronics that are not conducive to harsh dairy environments. Another shortcoming is the cost and complexity making it only suitable to be deployed in 500 cows, larger dairies or other large-scale applications. Another disadvantage is that the electronics are very complex and would require a trained technician to service and maintain them. The presently claimed logic-sensing mat solves these problems by eliminating expensive load transferring relays and associated wiring, and vastly simplifies and reduces programmable logic requirements to a very small compact disposable unit that can be replaced by service personal without intensive training.

In the '545 patent disclosed above, the system used a mat with 11 sensors. When pressure was applied to those sensors, a signal was sent to a processor that would in turn determine which valves where to be opened to spray a desired pattern. In addition, there was settling time to allow the foot to fully land, and for foot rotation time, meaning a continued spray after the foot lifted. All of these events were controlled by a computer. The present design does not require this complex system because the timing can be controlled by the properties of the pressure sensors as well as timers.

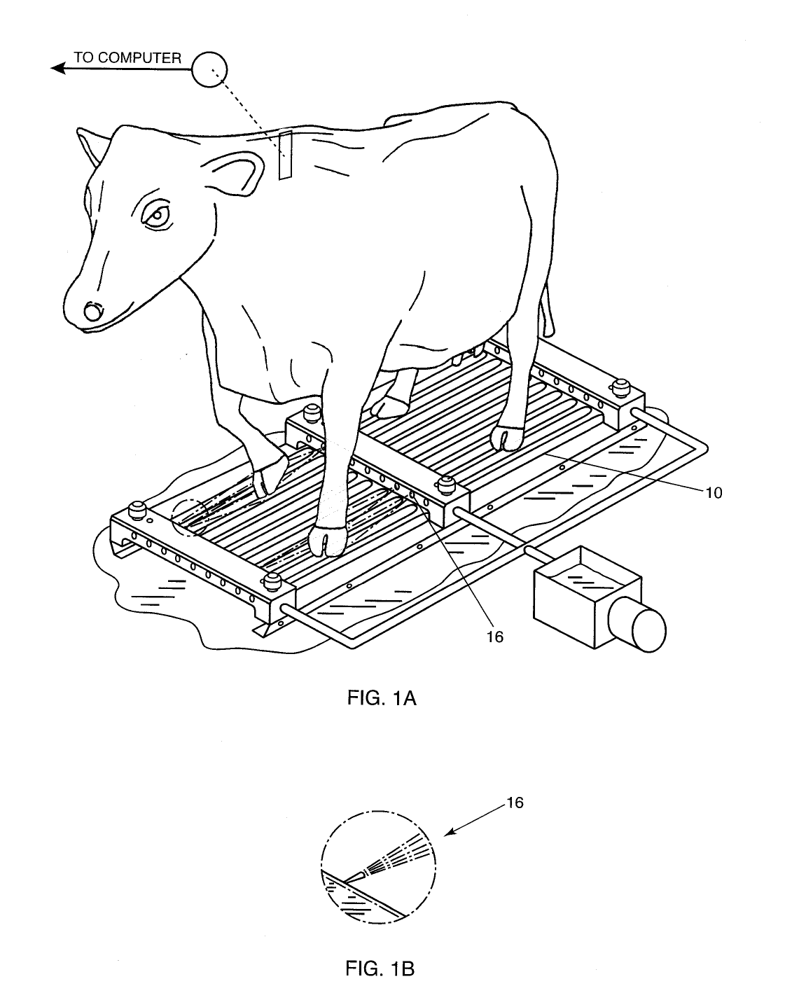

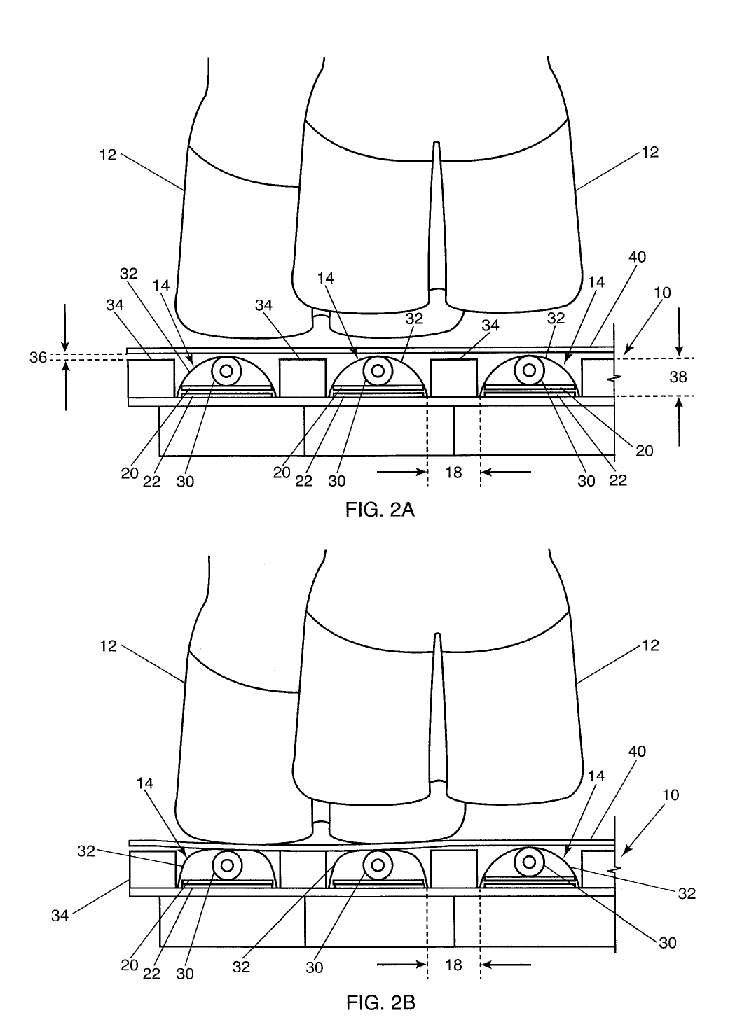

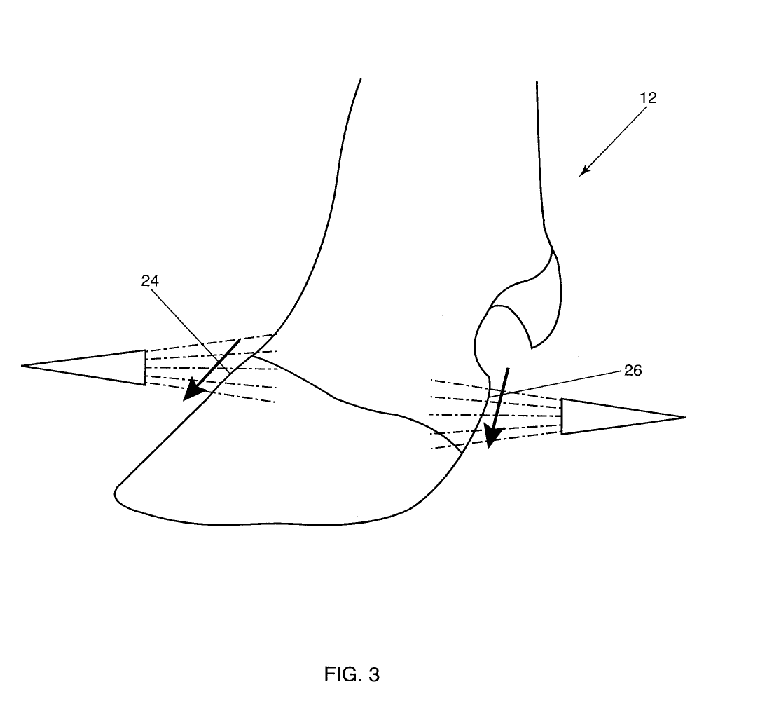

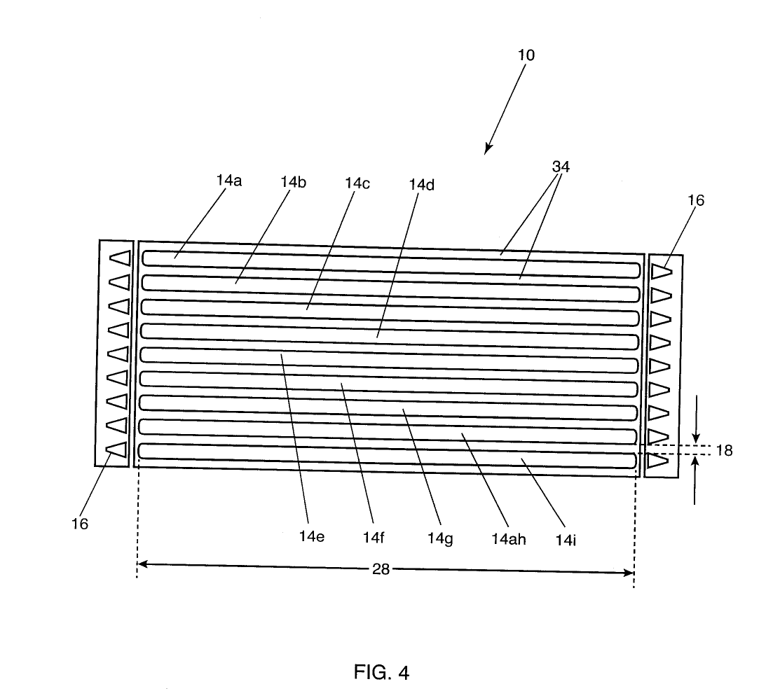

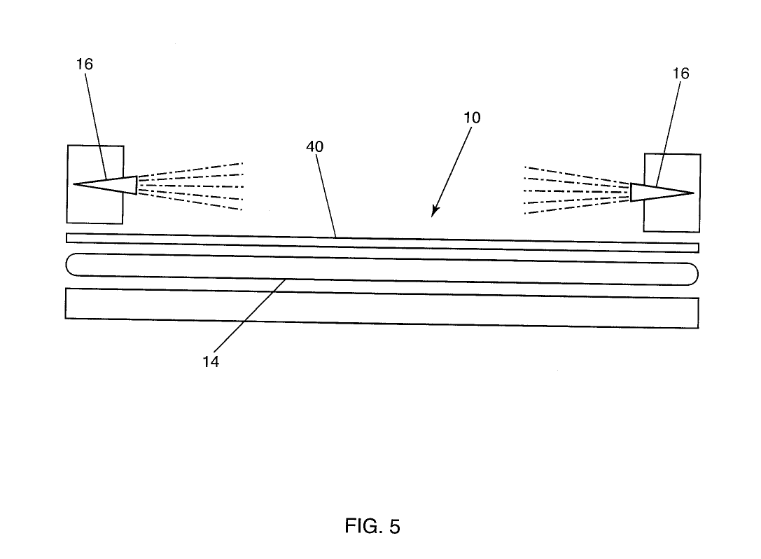

FIG. 1 shows a typical system installation. FIGS. 2-5 show the new mat design. In mat 10, the compression of the foot or hoof 12 is studied for depression and load bearing whereby pressure sensors 14 and spray nozzles 16 are placed at the correct spacing and angle to provide the spray coverage necessary. Mat 10 as shown in the figures is configured for dairy cows. Mat 10 in this embodiment has nine (9) pressure sensors 14a through 14i. Each pressure sensor 14 runs along the length of mat 10, as shown. Spacing 18 between each mat is optimized preferably so that each hoof 12 compresses at least two pressure sensors as shown in FIGS. 2A and 2B. Pressure sensors 14 essentially are switches, that when depressed by a weight bearing hoof 12, establishes contact between top contact plate 20 and bottom contact plate 22 that in turn activates corresponding spray nozzles 16. Each pressure sensor 10 is configured to activate at least two spray nozzles, a first nozzle 16′ aimed towards a front of hoof 24 and a second nozzle 16″ aimed at a rear of the hoof 26.

Pressure sensors 14 are preferably configured semicircular members 32, although any other configuration can be utilized. Running along length 28 of each sensor 14 is a firm flexible rubber tube 30, in the preferred configuration a PVC pipe, such as a flexible Santoprene® tube or the like. Firm flexible rubber tube 30 is embedded within semicircular member 32, as shown. Each semicircular member 32 is constructed from a compressible or highly elastic material, such as rubber. The elasticity or compressibility of the material should be optimized for the weight bearing or force exerted upon it. For example, a full-grown male bovine can weigh up to 3000 pounds and have a vertical jump of 3 feet or more landing with a force of over 20,000 psi. Thus, a thickness and type of compressible material for semicircular member 32 needs to be selected based on these criteria. The depth of firm flexible rubber tube 30 embedded in semicircular member 32 should also be optimized to avoid breaking or damaging firm flexible rubber tube 30 when in use. Also embedded in semicircular member 32 is top contact plate 20. Top contact plate 20 is preferably disposed directly below firm flexible rubber tube 30 so that when pressure is applied to a top of firm flexible rubber tube 30, it forces or pushes top contact plate 20 towards bottom contact plate 22. Once sufficient pressure is applied, contact is made between top contact plate 20 and bottom contact plate 22, essentially closing a switch. Attached to top contact plate 20 and bottom contact plate 22 can be valve assemblies for allowing the flow of the treatment liquid to hoof 12. Once the downward force is removed when the animal steps off pressure sensor 14, the contact is opened and the spray is stopped. A timer can also be utilized to turn off the spray, if desired. A delay in activating and deactivating the spray nozzles can be included due to the compression properties of the elastomers or via timers as discussed above. In the alternative, instead of the sensors described above, load cells can be utilized to detect pressure of the animal's foot and to activate the spray regime as discussed above.

Another feature in the presently claimed invention are load bearing or stop bars 34 that are disposed next to each side of each pressure sensor 14, running along length of sensor 28. Stop bars 34 are designed to prevent contraction of pressure sensors beyond a predetermined distance 36. Stop bars 34 prevent damage to pressure sensors 14 and lessen the amount of compressible material required to protect firm flexible tube 30 and top 20 and bottom contact plates 22. Height of stop bars 38 should correspond to distance required for achieving contact between the top contact plate 20 and bottom contact plate 22, hereinafter predetermined distance 36. Stop bars 34 can be constructed from any type of rigid or semi-rigid material, again depending on the force exerted by the animals being treated.

Preferably, a top cover 40 is disposed on top of all of pressure sensors 14, as show for additional protection of pressure sensors 14 and to keep debris and moisture from pressure sensors 14. Top cover can be constructed from a compressible or highly elastic material, such as rubber. By using a compressible material for top cover 40, the thickness of semicircular members 32 can be lessened.

The preferred mat as described above determines a settling time before the valves activate. In addition, the hardness firm flexible rubber tube 30 in mat 10 provides for a specific delay in operating the valves, as discussed above. Thus, no external timing control is required, only different types of material. This material timing system also operates to provide a timing delay in turning off the valves by providing differing “rebound” times when the force of the hoof is removed causing pressure sensor 14 to return to its original condition.

These advancements negate the need for costly and complex electronics, thereby reducing the cost and simplifying the device to be used by smaller facilities, and applications that are more diverse.

### Topical Anti-Inflammatory/Naso Dilator

During acidosis, brought on by “slug” feeding bovines, acidic levels change and trigger histamine reactions within its body, one of the points that are sensitive to this change are in its hooves. During those changes, capillaries reacting to histamines constrict to stop blood flow and release microphages and other white blood cells to counter what the animal's body is reading as a forging invasive organism. This leads to swelling in a space where a stiff horn wall surface does not allow expansion. As swelling starts, the swelling leads to compression and hemorrhaging of the cells on the micro level, leading to laminitis, lameness, white line disease, abscess, and ulcers on the macro level.

It was discovered in the field that the frequent use of topical anti-inflammatory/vaso dilation could successfully prevent this condition to a large degree. Therefore, a solution of 1.5%-7.5% of magnesium sulfate in water was used in the field test. Although this disclosure discusses magnesium sulfate and well known anti-inflammatory solution can be used. The number of treatments applied by a hoof trimmer to correct laminitis issues to a herd of 3200 cows was as follows:
In 2011, untreated animals required 462 surgical operations that were performed to remove large amounts of the cow's foot so that the blood and inflammation could drain and then a block was adhered to the treated foot to remove the pressure from the surgical site over a 5-month period.
In 2013, with treatment using the disclosed topical anti-inflammatory in the same herd, only 237 cows required surgical operations described above for a similar 5 months period.
Thus, a difference of 48.7% between untreated cows to treated cows.

### Identification for Treatment of Specific Animals

In dairy herds, there are different hoof problems that exist that only affect a small number of animals in a herd at a given time; typically, the number would be 30-100 incidents per 1000 cows. A footbath is common for the prevention of these diseases, meaning only after the cow has a lesion of 4 mm or larger will these prevention methods be ineffective. After that, a stronger and more concentrated formula must be used to cure these diseases. Typically, these cows are introduced into the herd when they start their first lactation or during non-lactating periods and then re-introduced into the herd. During these times, preventative hoof treatments stop and re-infection can and does occur. This system gives the producer the ability to tag or choose an animal that the system will recognize and alter its normal preventative function to an effective treatment function. This can be seen in FIG. 1A. A tag 42 can be placed on an animal for this special treatment. Tag 42 can be a transmitting sensor recognized by receiver 46 causing a computer or controller to initialize the treatment system for actuation upon hoof pressure on the mat as disclosed above. Tag 42 can be a microchip using radio frequency identification (RFID) or any other well-known system. The tag can also be visual or audio, whereby a user can manually initiate the treatment system. Another benefit of this treatment on dairy animals is stress that can induce worse problems such as laminitis, abscesses, ulcers, and white line, but can be prevented by allowing the treatment to be done without disrupting the animal's normal eating routine.

Without this system, an animal that has an infection needs to be sorted out of their pen, and placed in a pen where a hoof trimmer comes and cuts away the lesion, then applies a concentrated topical powder, and then wraps the hoof. During this time, the animal is under stress, in a strange area, with strange cows, which are seeking to establish a new social order, causing the cows to reduce feeding until the order is established. By the time this happens, the treatment has been done and the animal is moved back to their original pen, and the process repeats itself anew, to a smaller degree, setting up a situation for “slug” feeding that can lead to acidosis and the accompanying laminitis. Thus, the claimed invention provides for tagging only the animals that require treatment and applying the medicinal fluid only to these animals.

Although the claimed invention has been described in detail with particular reference to these preferred embodiments, other embodiments can achieve the same results. Variations and modifications of the presently claimed invention will be obvious to those skilled in the art and it is intended to cover in all such modifications and equivalents. The entire disclosures of all references, applications, patents, and publications cited above, are hereby incorporated by reference.

What is claimed is:

1. A sensing mat for an animal treatment system comprising:
a plurality of sensors; and
a load bearing bar on each side of each sensor.

2. The sensing mat of claim 1 further comprising a compressible elastomer disposed on the each sensor.

3. The sensing mat of claim 2 wherein the flexible elastomer is disposed between a contact surface of the sensing mat and the each sensor for limitation of excessive pressure on the each sensor.

4. The sensing mat of claim 1 wherein the each sensor comprises a load cell.

5. The sensing mat of claim 1 wherein each sensor is configured to activate at least one spray nozzle.

6. The sensing mat of claim 1 further comprising a delay for the activation and deactivation of an output of the each sensor.

7. The sensing mat of claim 1 wherein the load-bearing bar comprises a stop distance of travel when pressure is provided by the animal foot.

8. The sensing mat of claim 1 wherein a spacing between a first and a next pressure sensor and a width of each load bearing bar comprise a distance so that each animal's foot simultaneously depresses a predetermined number of sensors.

9. The sensing mat of claim 1 further comprising a protective covering for a plurality of sensors.

10. A method for treating laminitis in hooved animals, the method comprising the steps of:
a) providing a topical anti-inflammatory solution to an animal treatment system; and
b) applying the topical anti-inflammatory solution to the hoofs of the animal.

11. The method of claim 10 wherein the topical anti-inflammatory solution comprises magnesium sulfate.

12. The method of claim 10 wherein the step of applying comprises spraying the topical anti-inflammatory solution.

13. The method of claim 10 further comprising the step of repeating the application on a predetermined schedule.

14. A method for preventing or treating lameness in hooved animals, the method comprising the steps of:
a) providing a topical anti-inflammatory solution to an automated animal treatment system; and
b) applying the topical anti-inflammatory solution to the hoofs of the animal.

15. The method of claim 14 wherein the topical anti-inflammatory solution comprises magnesium sulfate.

16. The method of claim 14 further comprising the step of tagging specific animals for the treatment.

17. The method of claim 16 wherein the step of tagging comprises a tag member from the group of an automatic sensor, a visual tag for manual control and a combination of an automatic sensor and a manual controller.

18. A method of treating an animal's foot, the method comprising the steps of:
a) applying pressure to a predetermined number of sensors in a sensing mat by the animals foot;
b) stopping a travel distance of each sensor by load bearing bars; and
c) activating at least one spray nozzle by the each sensor.

19. The method of claim 18 further comprising the step of dampening a load on the each sensor.

20. The method of claim 18 further comprising the step of providing a delay for activating and deactivating an output of the each sensor.

22. The method of claim 18 wherein the step of stopping a traveled distance comprises stopping the travel distance simultaneously with a change of an output of the each sensor.

23. The method of claim 18 further comprising the step of protecting the sensing mat with a protective cover.
